(19) United States
(12) Patent Application Publication
(10) Pub. No.: US 2013/0100896 A1
(43) Pub. Date: Apr. 25, 2013

(54) METHOD AND DEVICE FOR TRANSMITTING APERIODIC SOUNDING REFERENCE SIGNAL (SRS)

(71) Applicants: Wenhong Chen, Beijing (CN); Deshan Miao, Beijing (CN); Xueming Pan, Beijing (CN); Shaohui Sun, Beijing (CN)

(72) Inventors: Wenhong Chen, Beijing (CN); Deshan Miao, Beijing (CN); Xueming Pan, Beijing (CN); Shaohui Sun, Beijing (CN)

(73) Assignee: CHINA ACADEMY OF TELECOMMUNICATIONS TECHNOLOGY, Beijing (CN)

(21) Appl. No.: 13/638,928

(22) PCT Filed: Mar. 10, 2011
(86) PCT No.: PCT/CN2011/071667

§ 371 Date: Dec. 13, 2012

(30) Foreign Application Priority Data
Mar. 31, 2010 (CN) 201010138981.8

(51) Int. Cl. H04W 72/04

(52) U.S. Cl. CPC H04W 72/042
USPC 370/329

(57) ABSTRACT

Embodiments of the present invention disclose a transmission method and device for aperiodic Sounding Reference Signal (SRS). By applying the technical solution of the embodiments in the present invention, a Base Station (BS) performing semi-static configuration of the aperiodic SRS on a mobile terminal through higher layer signaling to decrease signaling overhead. On the one hand, different sub-frames can be set with different or the same Cycle Shift (CS) and resource positions to increase the flexibility of system setting; On the other hand, aperiodic SRS may be transmitted in a plurality of sub-frames to reduce system delay and increase detection bandwidth. Moreover, the relatively flexible timing mode can be set in the terminal without bringing too many limits on the scheduling.

This application claims the priority to the Chinese Patent Application No. 201010138981.8 titled “Method and Device for Transmitting Aperiodic Sounding Reference Signal (SRS)” filed to the Patent Office of the People's Republic of China on Mar. 31, 2010, the entire disclosure of which is incorporated by reference herein.

### FIELD OF THE INVENTION

The present invention relates to the field of communication technology, in particular to the method and device for transmitting aperiodic Sounding Reference Signal (SRS).

### BACKGROUND OF THE INVENTION

In the existing system, the uplink channel sounding is realized through sounding signal. By sending sounding signal on the last symbol in SRS sub-frame through a terminal, a base station can get the uplink channel information, thus can conduct uplink transmit resource scheduling and measurement, including measurement of Rank Indication (RI)/Precoding Matrix Indicator (PMI)/Channel Quality Indication (CQI). SRS in Long Term Evolved (LTE) system is transmitted periodically, i.e., the terminal will send sounding signal on a periodic basis until it enters into a state of no data transmission. Parameters of periodic SRS are of higher layer configuration, including Cycle Shift (CS), bandwidth, frequency-hopping parameter and cycle of SRS as well as sub-frame position allowing transmission of SRS.

Periodic SRS often occupies a lot of physical resources because of long dispatching cycle and low dispatching efficiency. In particular in Long Term Evolved Advanced (LTE-A) system, a User Equipment (UE), i.e. a terminal, often needs to transmit multi-antenna SRS, thus there is a larger consumption of resources. To increase resource utilization of SRS and decrease resource consumption of SRS, aperiodic SRS transmission is introduced in the LTE-A system.

Different from periodic SRS, aperiodic SRS is dynamically activated by the base station. Once the terminal is activated, it will send the sounding signal for once only rather than periodically. Through aperiodic sounding signal, the base station can get necessary channel information in a more flexible way, i.e. to disable or cut down periodic SRS transmission if condition allows, thereby decreasing physical resource consumption of SRS.

Since both the periodic SRS and aperiodic SRS are transmitted on cell-specific SRS sub-frame, it is necessary to solve problems about how to conduct resource scheduling of aperiodic SRS in order to provide enough physical resources and how to ensure no resource conflict with the periodic SRS. Besides, after receiving the parameter configuration and activation signaling sent by the base station, the terminal can also transmit SRS in a flexible way.

The prior art comprises configuration of parameters of aperiodic SRS by introduction of SRS-specific Downlink Control Information (DCI) format in Physical Downlink Control Channel (PDCCH), and multiplexing with other uplink formats, e.g. format( ), by employing the same length, thus realizing dynamic configuration of resources. Upon receiving the control signaling sent by the base station, the terminal can conduct aperiodic SRS transmission according to the time-frequency resources indicated in the control signaling, and can also be activated by using only 1 bit signaling in Uplink grant (UL grant) or Downlink grant (DL grant) at the same time. Other parameters are set through high layer.

In the process of realizing the objects of the present invention, at least the following problems existing in the prior art were found:

In the prior art, configuration of aperiodic SRS by introduction of SRS-specific DCI format will greatly increase resource consumption of PDCCH, and may cause waste of resources to a certain degree because of few bits. In case of a plurality of activated users, the resource consumption will be too much for PDCCH.

### SUMMARY OF THE INVENTION

The embodiments of the present invention disclose a method and device for transmitting aperiodic SRS. A base station sets the parameters of aperiodic SRS through high layer and a terminal transmits the SRS according to the settings, thus it is possible to conduct resource scheduling and transmission of aperiodic SRS reasonably and effectively.

For the attainment of the above object, the embodiment of the present invention, in one aspect, provides a method for transmitting aperiodic Sounding Reference Signal (SRS), comprising:

The terminal receives the parameters of aperiodic SRS sent by the base station through higher layer signaling;

The terminal sends aperiodic SRS to the base station according to the configuration parameters of aperiodic SRS upon receiving the configuration parameters of aperiodic SRS sent by the base station.

In a further aspect, the embodiments of the present invention also provide a terminal, comprising:

A receiving module for the receiving parameters of aperiodic SRS and aperiodic SRS activation signaling sent by the base station through higher layer signaling;

A sending module used to send aperiodic SRS to the base station according to the parameters of aperiodic SRS received by the receiving module after the receiving module receives the aperiodic SRS activation signaling sent by the base station.

In still a further aspect, the embodiments of the present invention also provide a method for transmitting aperiodic SRS, comprising the following steps:

The base station sends the parameters of aperiodic SRS to the terminal through higher layer signaling;

The base station receives the aperiodic SRS sent by the terminal according to the parameters of aperiodic SRS upon sending the aperiodic SRS activation signaling to the terminal.

In still a further aspect, the embodiments of the present invention also provide a base station comprising:

A sending module used to send higher layer signaling including the parameters of aperiodic SRS and aperiodic SRS activation signaling to the terminal;

A receiving module used to receive the aperiodic SRS sent by the terminal according to the parameters of aperiodic SRS after the sending module sends the aperiodic SRS activation signaling to the terminal.

Compared with the prior art, the embodiments of the present invention have the following advantages:

By applying the technical solution of the embodiments in the present invention, and semi-static configuration through higher layer signaling, signaling overhead is decreased. Since different sub-frames can be set with different or the same Cycle Shift (CS) and resource positions, the system is of high flexibility; aperiodic SRS may be transmitted in a plurality of sub-frames to reduce system delay and increase detection bandwidth. Moreover, the relatively flexible timing mode can be set in the terminal without bringing too many limits on the scheduling.

### BRIEF DESCRIPTION OF THE DRAWINGS

For a better understanding of the technical solution in the embodiments of the present invention or the prior art, the drawings required to use in description of the embodiments or the prior art will be introduced briefly herein below. Obviously, the drawings described below are a plurality of embodiments of the present invention. Those skilled in the art can also get other drawings according to these drawings without creative work.

FIG. 1 is a flow diagram of a method for transmitting aperiodic SRS at the terminal side proposed by the embodiments of the present invention;

FIG. 2 is flow diagram of a method for transmitting aperiodic SRS at the base station side proposed by the embodiments of the present invention;

FIG. 3 is a flow diagram of a method for transmitting aperiodic SRS in a specific application proposed by the embodiments of the present invention;

FIG. 4 is a structural diagram of a terminal proposed by the embodiments of the present invention;

FIG. 5 is a structural diagram of a base station proposed by the embodiments of the present invention.

### DETAILED DESCRIPTION OF PREFERRED EMBODIMENTS

The technical solution in the embodiments of the present invention is explained in a clear and complete way with reference to the drawings in the embodiments of the present invention. Obviously, the embodiments described herein below are only a plurality of embodiments of the present invention rather than all. All other embodiments gained by those skilled in the art on the basis of the embodiments in the present invention without any creative work shall fall within the protection scope of the present invention.

In the existing technical solutions, periodic SRS needs to occupy more physical resources for introduction of multi-antenna transmission in LTE-A system. To improve SRS resource utilization and reduce SRS resource consumption, a aperiodic SRS transmission is introduced in the LTE-A system to activate the one-time sounding signal through dynamic scheduling.

It is necessary to solve problems about how to conduct resource scheduling of aperiodic SRS and how to send aperiodic SRS after the terminal receives the signaling sent by the base station.

The embodiments of the present invention provide a method for transmitting aperiodic SRS. A base station sets the parameters of aperiodic SRS through high layer signaling and a terminal transmits SRS according to the settings, thus it is possible to conduct resource scheduling and transmission of aperiodic SRS reasonably and effectively.

For the purpose of solving the problems existed in the prior art, the embodiments of the present invention present a method for transmitting aperiodic SRS in consideration of the compatibility of LTE system.

The embodiments of the present invention provide a method for transmitting aperiodic SRS comprising the following steps: the base station informs the terminal through higher layer signaling of setting the parameters of aperiodic SRS, and the terminal transmits aperiodic SRS according to the corresponding settings of parameters in a flexible way.

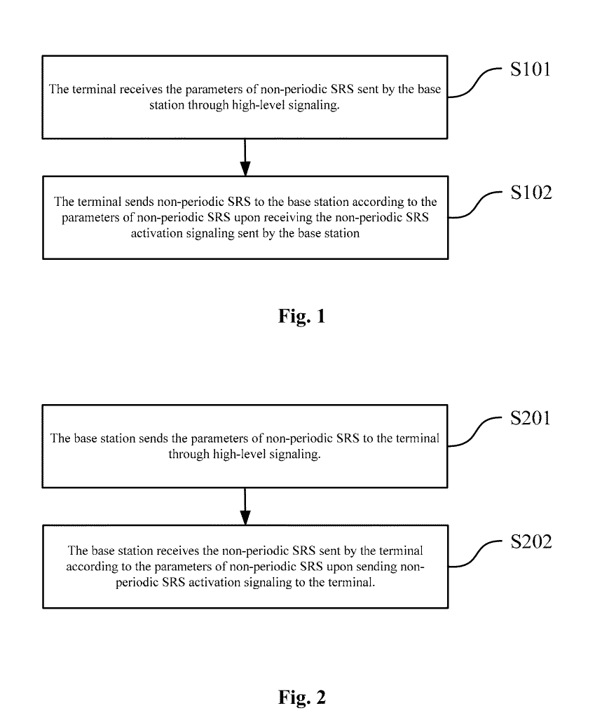

FIG. 1 is a flow diagram of a method for transmitting aperiodic SRS disclosed by the embodiments of the present invention comprising the following steps:

Step S101 the terminal receiving the parameters of aperiodic SRS sent by the base station through higher layer signaling.

Wherein, the parameters of aperiodic SRS include:

(1) Sub-frame configuration information of SRS, comprising configuration cycle of sub-frame.

(2) Frequency domain configuration information of SRS, comprising the following one or more parameter(s):

Initial location of frequency domain resource, transmission bandwidth, transmission comb and frequency-hopping bandwidth.

Frequency domain configuration information of SRS in specific application scenarios comprises:

Information set separately for transmission sub-frames of aperiodic SRS of the terminal in a cycle; or,

Information set for all transmission sub-frames of aperiodic SRS of the terminal.

(3) Cycle shift value

It should be further noted that if the aperiodic SRS supports one-port transmission, the parameters of aperiodic SRS also include:

(4) SRS transmission mode information.

Step S102: the terminal sending aperiodic SRS to the base station according to the parameters of aperiodic SRS upon receiving the aperiodic SRS activation signaling sent by the base station, specifically:

The terminal sends aperiodic SRS to the base station in the current sub-frame according to the parameters of aperiodic SRS upon receiving the aperiodic SRS activation signaling and presetting a plurality of sub-frames; or,

The terminal sends aperiodic SRS to the base station in the nearest one or more aperiodic SRS transmission sub-frame(s) of the current sub-frame according to the parameters of aperiodic SRS upon receiving the aperiodic SRS activation signaling and presetting a plurality of sub-frames.

It should be further noted that if the terminal received more than once activation commands between two transmissions of aperiodic SRS, the terminal sends aperiodic SRS to the base station in the nearest aperiodic SRS transmission sub-frame for only once.

The above processing flow is for a method for transmitting aperiodic SRS disclosed by the embodiments of the present invention at the terminal side. Accordingly, the embodiments of the present invention further provide the flow at the base station side.

FIG. 2 is a flow diagram of a method for transmitting aperiodic SRS at the base station side provided by the embodiments of the present invention comprising the following steps:

Step S201: the base station sending the parameters of aperiodic SRS to the terminal through higher layer signaling.

Wherein, the parameters of aperiodic SRS are as described in step S101 and will not be described hereinafter repeatedly.

Step S202: the base station receiving the aperiodic SRS sent by the terminal according to the parameters of aperiodic SRS upon sending aperiodic SRS activation signaling to the terminal.

Corresponding to the two transmission policies in step S102, the execution flow of this step is:

The base station receives the aperiodic SRS sent by the terminal in the current sub-frame according to the parameters of aperiodic SRS upon receiving the aperiodic SRS activation signaling and presetting a plurality of sub-frames; or,

The base station receives the aperiodic SRS sent by the terminal in the nearest one or more aperiodic SRS transmission sub-frame(s) of the current sub-frame according to the parameters of aperiodic SRS upon receiving the aperiodic SRS activation signaling and presetting a plurality of sub-frames.

Compared with the prior art, the embodiments of the present invention have the following advantages:

By applying the technical solution of the embodiments in the present invention, a Base Station (BS) performs semi-static configuration of the aperiodic SRS on a mobile terminal through higher layer signaling to decrease signaling overhead. On the one hand, different sub-frames can be set with different or the same Cycle Shift (CS) and resource positions to increase the system configuration flexibility; On the other hand, aperiodic SRS may be transmitted in a plurality of sub-frames to reduce system delay and increase detection bandwidth. Moreover, the relatively flexible timing mode can be set in the terminal without bringing too many limits on the scheduling.

The technical solution disclosed in the embodiments of the prevent invention are described hereinbelow in connection with the specific application scenarios:

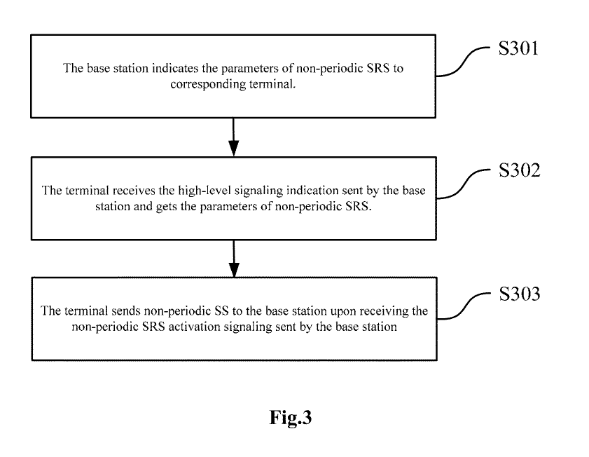

As shown in FIG. 3, which is a flow diagram of a method for transmitting aperiodic SRS in a specific application provided by the embodiments of the present invention, the method comprises the following steps:

Step S301: the base station indicating the parameters of aperiodic SRS to corresponding terminal, at least comprising the following contents:

(1) Sub-frame configuration of SRS

It is used to indicate the position of sub-frame allowing transmission of aperiodic SRS.

Wherein, it can also include the indication of parameters such as the configuration cycle of sub-frame. Corresponding cycle can be predetermined rather than indicated by the signaling.

(2) Frequency domain configuration of SRS

It is used to indicate the position of frequency domain resource occupied by transmission of sounding.

Wherein, the frequency domain configuration of SRS comprises the indication of parameters such as the initial position of frequency domain resource, transmission bandwidth, transmission comb and frequency hopping bandwidth. Sounding frequency domain can be set for aperiodic SRS transmission sub-frames in a certain period separately, or for all aperiodic SRS transmission sub-frames in a unified way;

(3) Cycle shift value

It is used to indicate the cycle shift of SRS sequence on one or more antenna(s). For example, the LTE method can be reused to indicate the cycle shift value of a first antenna (port), and the cycle shift value of other antennas (ports) are gained by predefinition. The cycle shift value can be set for aperiodic SRS transmission sub-frames in a certain period separately, or for all aperiodic SRS transmission sub-frames in a unified way.

It should be noted that if the aperiodic SRS supports one-port transmission, the parameters also include:

(4) SRS transmission mode setting for indicating that the terminal transmits SRS by adopting one-port or multi-port (antenna) mode;

In specific application scenarios, aperiodic SRS parameters and periodic SRS parameters are set separately, but it does not rule out the possibility that the parameters of two are the same.

Step S302: the terminal receiving the higher layer signaling indication sent by the base station and gets parameters of aperiodic SRS.

Step S303: the terminal sending aperiodic SRS to the base station upon receiving the aperiodic SRS activation signaling sent by the base station.

There is a plurality of ways for sending the aperiodic SRS as described hereinbelow:

Case I: the terminal sends aperiodic SRS after k sub-frames upon receiving the activation signaling. The aperiodic SRS transmission parameters are gained by following the aforesaid step S201.

Case II: the terminal sends aperiodic SRS within a plurality of nearest aperiodic SRS transmission sub-frames after k sub-frames upon receiving the activation signaling.

For instance, the terminal might send the aperiodic SRS within the nearest one aperiodic SRS transmission sub-frame. Aperiodic SRS transmission parameters are also gained by following the aforesaid step S201.

It is to be noted that the k should be a nonnegative integer, and typical values including k=0 or k=4. The variation of value shall not influence the protection scope of the present invention.

if the terminal received more than once activation commands between two transmissions of aperiodic SRS, the terminal sends the aperiodic SRSs to the base station in the nearest aperiodic SRS transmission sub-frame for only once.

The present invention which is widely applicable can be used for the uplink transmission in the following scenarios:

Arbitrary antenna quantity and antenna array, linear array and polarization sensitive array;

Arbitrary duplexing system, Time Division Duplexing (TDD) system or Frequency Division Duplexing (FDD) system;

Arbitrary sending mode, Single User Multiple Input Multiple Output (SU-MIMO), Multiple User Multiple Input Multiple Output (MU-MIMO), Coordinated Multiple Point Transmission and Reception (CoMP) for instance.

Compared with the prior art, the embodiments of the present invention have the following advantages:

By applying the technical solution of the embodiments in the present invention, a Base Station (BS) performs semi-static configuration of the aperiodic SRS on a mobile terminal through higher layer signaling to decrease signaling overhead. On the one hand, different sub-frames can be set with different or the same Cycle Shift (CS) and resource positions to increase the system configuration flexibility; On the other hand, aperiodic SRS may be transmitted in a plurality of sub-frames to reduce system delay and increase detection bandwidth. Moreover, the relatively flexible timing mode can be set in the terminal without bringing too many limits on the scheduling.

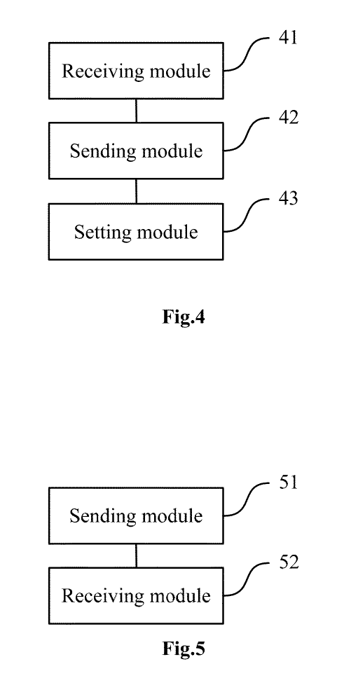

For the implementation of the technical solution described in the embodiments of the present invention, the embodiments of the present invention also provide a terminal, the structural diagram of which is shown in FIG. 4, comprising:

A receiving module 41 used to receive parameters of aperiodic SRS and aperiodic SRS activation signaling sent by the base station through higher layer signaling;

Preferably, the parameters of aperiodic SRS comprising:

Sub-frame configuration information of SRS;

Frequency domain configuration information of SRS;

Cycle shift value.

Preferably, if the aperiodic SRS supports one-port transmission, the parameters of aperiodic SRS also include:

SRS transmission mode information.

A sending module 42 used to send aperiodic SRS to the base station according to the parameters of aperiodic SRS received by the receiving module 41 after the receiving module 41 receives the aperiodic SRS activation signaling sent by the base station.

The terminal further includes:

A setting module 43 used to set the aperiodic SRS sending policy for the sending module 42, which comprises the following steps:

The terminal sends aperiodic SRS to the base station in the current sub-frame according to the parameters of aperiodic SRS upon receiving the aperiodic SRS activation signaling and presetting a plurality of sub-frames; or,

The terminal sends aperiodic SRS to the base station in the nearest one or more aperiodic SRS transmission sub-frame(s) of the current sub-frame according to the parameters of aperiodic SRS upon receiving the aperiodic SRS activation signaling and presetting a plurality of sub-frames.

Accordingly, the embodiments of the present invention also provide a base station, the structural diagram of which is as shown in FIG. 5, comprising:

A sending module 51 used to send higher layer signaling including the parameters of aperiodic SRS and aperiodic SRS activation signaling to the terminal;

A receiving module 52 used to receive the aperiodic SRS sent by the terminal according to the parameters of aperiodic SRS after the sending module 51 sends the aperiodic SRS activation signaling to the terminal.

Wherein, the specific content of the parameters of aperiodic SRS have been described hereinabove and will not be further described hereinbelow.

Compared with the prior art, the embodiments of the present invention have the following advantages:

By applying the technical solution of the embodiments in the present invention, a Base Station (BS) performs semi-static configuration of the aperiodic SRS on a mobile terminal through higher layer signaling to decrease signaling overhead. On the one hand, different sub-frames can be set with different or the same Cycle Shift (CS) and resource positions to increase the system configuration flexibility; On the other hand, aperiodic SRS may be transmitted in a plurality of sub-frames to reduce system delay and increase detection bandwidth. Moreover, the relatively flexible timing mode can be set in the terminal without bringing too many limits on the scheduling.

With the description of the preferred embodiments hereinabove, those skilled in the art can clearly understand that the present invention can be realized with the aid of software and necessary commonly used hardware platforms, or the aid of hardware of course, but the former is a preferred embodiment in most cases. Based on this understanding, the technical proposal of the present invention or the part contributing to the prior art can be reflected in the form of a software product, which is saved in a memory medium comprising instructions to enable a computer, which could be a personal computer, a server or a network device, to carry out the methods for each embodiment of the present invention.

Those skilled in the art can understand that the drawings are only schematic drawings of a preferred embodiment, and the module or procedure in the drawings is not necessarily a must for the embodiments of the present invention.

Those skilled in the art can understand that the modules in the device of the embodiments can be distributed in the device of the embodiments according to the description of the embodiments, and can be placed in a or more device(s) different from the embodiment after corresponding changes as well. The aforesaid modules of the embodiment can be incorporated into a module or further split into a plurality of modules.

The aforesaid serial number of the embodiments of the present invention is used only for description and shall not indicate any rank of the embodiments with respect to advantages or disadvantages.

The aforesaid disclosures are only a plurality of embodiments of the present invention and the present invention is not confined to them. All changes that those skilled in the art can think of shall fall within the protection scope of the present invention.

1. A method for transmitting aperiodic SRS, comprising:
A terminal receiving the parameters of aperiodic SRS sent by a base station through higher layer signaling;
The terminal sending aperiodic SRS to the base station according to the parameters of aperiodic SRS upon receiving the aperiodic SRS activation signaling sent by the base station.

2. The method of claim 1, wherein the parameters of aperiodic SRS include:
Sub-frame configuration information of SRS;
Frequency domain configuration information of SRS;
Cycle shift value.

3. The method of claim 2, wherein the sub-frame configuration of SRS comprises:
Configuration cycle of sub-frame.

4. The method of claim 2, wherein the frequency domain configuration information comprises one or more of the following parameter(s):
Initial location of frequency domain resource, transmission bandwidth, transmission comb and frequency-hopping bandwidth.

5. The method of claim 4, wherein the frequency domain configuration information of SRS comprises:
Information set separately for transmission sub-frames of aperiodic SRS of the terminal in a cycle; or,
Information set for all transmission sub-frames of aperiodic SRS of the terminal.

6. The method of claim 2, wherein, if the aperiodic SRS supports one-port transmission, the parameters of aperiodic SRS also include:
SRS transmission mode information.

7. The method of claim 1, wherein, the terminal sending aperiodic SRS to the base station according to the parameters of aperiodic SRS upon receiving the aperiodic SRS activation signaling sent by the base station, specifically:
The terminal sending aperiodic SRS to the base station in the current sub-frame according to the parameters of aperiodic SRS upon receiving the aperiodic SRS activation signaling and presetting a plurality of sub-frames; or,
The terminal sending aperiodic SRS to the base station in the nearest one or more aperiodic SRS transmission sub-frame(s) of the current sub-frame according to the parameters of aperiodic SRS upon receiving the aperiodic SRS activation signaling and presetting a plurality of sub-frames.

8. A terminal, comprising:
A receiving module used to receive a higher layer signaling including parameters of aperiodic SRS and aperiodic SRS activation signaling sent by the base station;
A sending module used to send aperiodic SRS to the base station according to the parameters of aperiodic SRS received by the receiving module after the receiving module receives the aperiodic SRS activation signaling sent by the base station.

9. The terminal of claim 8, wherein the aperiodic configuration parameters which comprise:
Sub-frame information of SRS;
Frequency domain configuration information of SRS;
Cycle shift value.

10. The terminal of claim 9, wherein, if the aperiodic SRS supports one-port transmission, the parameters of aperiodic SRS also include:
SRS transmission mode information.

11. The terminal of claim 8, wherein, which also includes:
A setting module used to set the aperiodic SRS sending policy for the sending module, which comprises the following steps:
The terminal used to send aperiodic SRS to the base station in the current sub-frame according to the parameters of aperiodic SRS upon receiving the aperiodic SRS activation signaling and presetting a plurality of sub-frames; or,
The terminal used to send aperiodic SRS to the base station in the nearest one or more aperiodic SRS transmission sub-frame(s) of the current sub-frame according to the parameters of aperiodic SRS upon receiving the aperiodic SRS activation signaling and presetting a plurality of sub-frames.

12. A method for transmitting aperiodic SRS, wherein the method comprises:
The base station sending the parameters of aperiodic SRS to the terminal through higher layer signaling;
The base station receiving the aperiodic SRS sent by the said terminal according to the parameters of aperiodic SRS upon sending aperiodic SRS activation signaling to the terminal.

13. The method of claim 12, wherein the parameters of aperiodic SRS which comprise:
Sub-frame configuration information of SRS;
Frequency domain configuration information of SRS;
Cycle shift value.

14. The method of claim 13, wherein the sub-frame configuration information of SRS which also comprises:
Configuration cycle of sub-frame.

15. The method of claim 13, wherein the frequency domain configuration information which also comprises one or more of the following parameter(s):
Initial location of frequency domain resource, transmission bandwidth, transmission comb and frequency-hopping bandwidth of frequency domain.

16. The method of claim 15, wherein the frequency domain configuration information which comprises:
Information set separately for transmission sub-frames of aperiodic SRS of the terminal in a cycle; or,
Information set for all transmission sub-frames of aperiodic SRS of the terminal.

17. The method of claim 13, wherein if the aperiodic SRS supports one-port transmission, the parameters of aperiodic SRS also comprise:
SRS transmission mode information.

18. The method of claim 12, wherein the base station receiving the aperiodic SRS sent by the terminal according to the parameters of aperiodic SRS upon sending aperiodic SRS activation signaling to the terminal, specifically:
The base station receiving the aperiodic SRS sent by the terminal in the current sub-frame according to the parameters of aperiodic SRS upon receiving the aperiodic SRS activation signaling and presetting a plurality of sub-frames; or,
The base station receiving the aperiodic SRS sent by the terminal in the nearest one or more aperiodic SRS transmission sub-frame(s) of the current sub-frame according to the parameters of aperiodic SRS upon receiving the aperiodic SRS activation signaling and presetting a plurality of sub-frames.

19-21. (canceled)
